(19) United States
(12) Patent Application Publication
(10) Pub. No.: US 2007/0265394 A1
(43) Pub. Date: Nov. 15, 2007

(54) Polyvinyl Acetate Solid Resins Functionalised with Acid Groups

(75) Inventors: Rene Grawe, Burghausen (DE); Andreas Lumpp, Brasilien (BR)

Correspondence Address: BROOKS KUSHMAN P.C., 1000 TOWN CENTER, TWENTY-SECOND FLOOR, SOUTHFIELD, MI, 48075, US

(73) Assignee: WACKER POLYMER SYSTEMS GMBH & CO. KG, Burghausen (DE)

(21) Appl. No.: 11/570,606

(22) PCT Filed: Jun. 23, 2005
(86) PCT No.: PCT/EP05/06821

§ 371 Date: Dec. 14, 2006

(30) Foreign Application Priority Data
Jul. 1, 2004 (DE) 10 2004 031 968.5

(51) Int. Cl. C08L 53/00

(52) U.S. Cl. 525/90; 525/185

(57) ABSTRACT

Solid polyvinyl acetate resins functionalized by acid groups which also contain terminal carboxy groups besides carboxy-functional comonomer units display superior properties as low profile additives for unsaturated polyester resins.

The invention relates to solid polyvinyl acetate resins functionalized by acid groups, to a process for their preparation, and also to use as a low-profile additive.

Production of sheet-like plastics parts often uses unsaturated polyester resins (UP resins), which are reinforced by means of glass fibres or carbon fibres. In order to reduce shrinkage during curing of the polyester resin, materials known as low-profile additives are added to this resin. The low-profile additive reduces shrinkage during curing, dissipates internal stresses, reduces formation of microcracks, and makes it easier to comply with manufacturing tolerances. The low-profile additives are thermoplastics, such as polystyrene, polymethyl methacrylate, and in particular polyvinyl acetate, and these often also contain carboxy-functional comonomer units. When low-profile additives are used, good solubility in styrene is desirable, as is low initial viscosity of the styrene solution and rapid thickening effect with a stable final level. Conventional low-profile additives, for example those based on polyvinyl acetates having carboxy-functional comonomer units, remain insufficiently satisfactory in relation to initial viscosity and thickening effects.

It was therefore an object to provide solid polyvinyl acetate resins optimized with respect to the abovementioned property profile for low-profile additives.

The invention provides solid polyvinyl acetate resins functionalized by acid groups, characterized in that the solid polyvinyl acetate resin also contains terminal carboxy groups, besides carboxy-functional comonomer units.

The solid resin functionalized by acid groups is preferably obtainable via polymerization of

a) from 85 to 99.8% by weight of vinyl acetate, and

b) from 0.1 to 10% by weight of one or more ethylenically unsaturated monocarboxylic acids, in the presence of

c) from 0.1 to 5% by weight of one or more mercaptoalkylcarboxylic acids having from 2 to 6 carbon atoms,

the data in % by weight giving a total of 100% by weight.

It is preferable to use from 90 to 99% by weight of vinyl acetate.

Preferred ethylenically unsaturated monocarboxylic acids are acrylic acid, methacrylic acid, crotonic acid. The proportion preferably polymerized of the ethylenically unsaturated acids is from 0.2 to 5% by weight, based on the total weight of components a) to c).

The mercaptoalkylcarboxylic acids serve to introduce the terminal carboxy groups. Mercaptoacetic acid and mercaptopropionic acid are preferred. The preferred proportion used of the mercaptoalkylcarboxylic acids is from 0.2 to 1% by weight, based on the total weight of components a) to c).

The weight-average molecular weight Mw of the solid polyvinyl acetate resins functionalized by acid groups is from 10 000 to 500 000.

The invention also provides a process for production of the solid polyvinyl acetate resins functionalized by acid groups via polymerization of vinyl acetate and of one or more ethylenically unsaturated monocarboxylic acids, in the presence of one or more mercaptoalkyl-carboxylic acids.

The solid polyvinyl acetate resins functionalized by acid groups are prepared by the bulk, suspension, or preferably solution polymerization process. Examples of suitable solvents are monohydric, aliphatic alcohols having from 1 to 6 carbon atoms, preferably methanol, ethanol, propanol, isopropanol. Particular preference is given to ethanol and isopropanol. The reaction is generally carried out under reflux conditions, generally at a polymerization temperature of from 40° C. to 140° C., in order to utilize evaporative cooling to dissipate the heat of reaction. This can take place at atmospheric pressure or else under slightly super-atmospheric pressure. Initiators used comprise organic peroxides or azo compounds. Examples of suitable compounds are diacyl peroxides, such as dilauroyl peroxide, peroxoesters, such as tert-butyl peroxopivalate or tert-butylperoxo-2-ethylhexanoate, or peroxodicarbonates, such as diethyl peroxodicarbonate. The amount of initiator is generally from 0.01 to 5.0% by weight, based on the monomers. The initiators may either form an initial charge or else form a feed. In a method which has proven successful here, a portion of the initiators required forms an initial charge and the remainder is fed continuously during the reaction.

A batch process may be used to prepare the polymers, all of the components of the polymerization mixture forming an initial charge in the reactor, or a semi-batch process may be used, one or more components forming an initial charge and the remainder forming a feed, or a continuous polymerization process may be used, the components forming a feed used during the polymerization process. The feeds may if appropriate be separate (spatially and chronologically). At least some of the mercaptoalkylcarboxylic acid portion preferably forms a feed used during the polymerization process. Once the exothermic reaction has ended, the remaining free monomers and the solvent are preferably removed by distillation. In order to obtain very low VOC content, the internal temperature is increased up to 100° C.-160° C., and a vacuum is then applied.

For the application as low-profile additive, the solid polyvinyl acetate resin functionalized by acid groups is dissolved in a known manner in styrene and applied, if appropriate with other additives, such as fillers, thickeners, initiators, and processing aids.

The combination of copolymerized carboxy groups in the polymer chain and terminal carboxy groups at the chain end gives resin solutions in styrene which when blended with fillers exhibit low initial viscosity and a rapid thickening effect, the stable end level having been achieved after as little as 1 day.

The examples below serve for further illustration of the invention:

### INVENTIVE EXAMPLE 1

350 g of methanol, 540 g of vinyl acetate and 3.5 g of crotonic acid formed an initial charge in a 4 litre reactor, to which 33 g of a 15% strength methanolic di-tert-butyl perpivalate solution was fed over a period of 4 hours while the mixture boiled gently at 150 rpm. After 30 minutes, a mixture composed of 1220 g of vinyl acetate, 14 g of mercaptopropionic acid and 9 g of crotonic acid was fed over a period of 3.5 hours. Once the feeds had ended, the reaction was continued for a further 2 h at the boiling point, and then the solvent and residual monomer were removed by distillation.

### INVENTIVE EXAMPLE 2

140 g of methanol, 540 g of vinyl acetate and 3.5 g of crotonic acid formed an initial charge in a 4 litre reactor, to which 33 g of a 15% strength methanolic di-tert-butyl perpivalate solution was fed over a period of 4 hours while the mixture boiled gently at 150 rpm. After 30 minutes, a mixture composed of 1220 g of vinyl acetate, 14 g of mercaptopropionic acid and 9 g of crotonic acid was fed over a period of 3.5 hours. Once the feeds had ended, the reaction was continued for a further 2 h at the boiling point, and then the solvent and residual monomer were removed by distillation.

### COMPARATIVE EXAMPLE 3

350 g of methanol, 540 g of vinyl acetate and 3.5 g of mercaptopropionic acid formed an initial charge in a 4 litre reactor, to which 33 g of a 15% strength methanolic di-tert-butyl perpivalate solution was fed over a period of 4 hours while the mixture boiled gently at 150 rpm. After 30 minutes, a mixture composed of 1220 g of vinyl acetate, 21 g of mercaptopropionic acid was fed over a period of 3.5 hours. Once the feeds had ended, the reaction was continued for a further 2 h at the boiling point, and then the solvent and residual monomer were removed by distillation.

### COMPARATIVE EXAMPLE 4

210 g of methanol, 540 g of vinyl acetate formed an initial charge in a 4 litre reactor, to which 33 g of a 15% strength methanolic di-tert-butyl perpivalate solution was fed over a period of 4 hours while the mixture boiled gently at 150 rpm. After 30 minutes, a mixture composed of 1220 g of vinyl acetate, 14 g of mercaptopropionic acid was fed over a period of 3.5 hours. Once the feeds had ended, the reaction was continued for a further 2 h at the boiling point, and then the solvent and residual monomer were removed by distillation.

### COMPARATIVE EXAMPLE 5

The procedure was analogous to that of Comparative Example 4, except that there was no feed of mercapto-propionic acid.

### COMPARATIVE EXAMPLE 6

350 g of methanol, 540 g of vinyl acetate and 3.5 g of crotonic acid formed an initial charge in a 4 litre reactor, to which 33 g of a 15% strength methanolic di-tert-butyl perpivalate solution was fed over a period of 4 hours while the mixture boiled gently at 150 rpm. After 30 minutes, a mixture composed of 1220 g of vinyl acetate, and 14 g of crotonic acid was fed over a period of 3.5 hours. Once the feeds had ended, the reaction was continued for a further 2 h at the boiling point, and then the solvent and residual monomer were removed by distillation.

The following procedure was used to test thickening effects:

In each case, a composition composed of 120 g of a 40% strength solution of the solid resin in styrene, 180 g of calcium carbonate filler (Omyacarb 5GU) and 3 g of magnesium oxide (Luvakol MK-35) was tested as follows: 120 g of the solid resin solution formed an initial charge in a 250 ml glass vessel with screw closure, and 180 g of the calcium carbonate were incorporated in portions by stirring with a blade stirrer at relatively high speed (about 800-1200 rpm) until a homogeneous mixture was obtained at a temperature of 27° C. 3 g of the magnesium oxide were then incorporated by stirring for 1 minute at 2000 rpm, and temperature and viscosity (Helipath) were immediately determined. The viscosity measurement was repeated after 3 hours, after one day and after 7 days. The results are given in the table.

TABLE

| | Inv. | Inv. | Comp. | Comp. | Comp. | Comp. |
|---|---|---|---|---|---|---|
| | Ex. 1 | Ex. 2 | Ex. 3 | Ex. 4 | Ex. 5 | Ex. 6 |
| Crotonic acid [% by wt.] | 0.7 | 0.7 | 0.0 | 0.0 | 0.0 | 1.0 |
| MPA [% by wt.] | 0.8 | 0.8 | 1.4 | 0.8 | 0.0 | 0.0 |
| Mol. wt. [Mw] | 76 000 | 85 000 | 40 000 | 85 000 | 130 000 | 84 000 |
| Viscosity [Pas] 0 h | 11 | 12 | 3 | 12 | 147 | 32 |
| Viscosity [Pas] 3 h | 14 800 | 12 900 | 7 | 29 | 153 | 706 |
| Viscosity [Pas] 1 d | 33 000 | 25 500 | 10 | 39 | 154 | 24 800 |
| Viscosity [Pas] 7 d | 33 000 | 25 000 | 10 | 45 | 182 | 33 000 |

The test results show that solid resins which contain carboxy groups not only in the chain but also terminally give the required property profile of low initial viscosity (0 h), rapid thickening (3 h), and stable viscosity after one day (Inventive Examples 1/2).

If only terminal carboxy groups are present, although low initial viscosity is obtained no thickening is obtained (Comparative Examples 3/4).

Without terminal carboxy groups there is a marked delay in thickening (Comparative Example 6).

With no carboxy groups at all the result is high initial viscosity and no subsequent viscosity rise (Comparative Example 7).

1-6. (canceled)

7. In a process wherein unsaturated polyester resin compositions containing low-profile additive(s) are polymerized, the improvement comprising incorporating into the unsaturated polyester resin composition at least one low profile additive comprising a solid polyvinylacetate copolymer resin bearing carboxy groups along the polyvinylacetate copolymer chain and also bearing at least one terminal carboxy group.

8. The process of claim 7, where the solid polyvinyl acetate resin is obtained by polymerization of
a) from 85 to 99.8% by weight of vinyl acetate, and
b) from 0.1 to 10% by weight of one or more ethylenically unsaturated monocarboxylic acids,
in the presence of
c) from 0.1 to 5% by weight of one or more mercaptoalkylcarboxylic acids having from 2 to 6 carbon atoms.

9. The process of claim 8, wherein at least one ethylenically unsaturated monocarboxylic acid selected from the group consisting of acrylic acid, methacrylic acid, and crotonic acid are copolymerized with vinyl acetate.

10. The process of claim 8, wherein the polymerization takes place in the presence of at least one of mercaptoacetic acid or mercaptopropionic acid.

11. The process of claim 7, wherein said low profile additive comprises a copolymer of vinyl acetate, one or more of acrylic acid, methacrylic acid, or crotonic acid, and at least one of mercaptoacetic acid or mercaptopropionic acid.

12. The process of claim 8, wherein said low profile additive is a copolymer of vinyl acetate, one or more of acrylic acid, methacrylic acid, or crotonic acid, and at least one of mercaptoacetic acid or mercaptopropionic acid.

13. The process of claim 8, wherein vinyl acetate is polymerized in an amount of from 90 to 99 weight percent based on total monomer weight.

14. The process of claim 8, wherein the proportion of unsaturated carboxylic acid is from 0.2 to 5% by weight based on total monomer weight.

15. The process of claim 8, wherein the proportion of mercaptoalkylcarboxylic acid is from 0.2 to 1% by weight based on total monomer weight.

16. The process of claim 13, wherein the proportion of unsaturated carboxylic acid is from 0.2 to 5% by weight based on total monomer weight.

17. The process of claim 13, wherein the proportion of mercaptoalkylcarboxylic acid is from 0.2 to 1% by weight based on total monomer weight.

18. The process of claim 14, wherein the proportion of mercaptoalkylcarboxylic acid is from 0.2 to 1% by weight based on total monomer weight.

19. The process of claim 7, wherein the low profile additive is dissolved in styrene.
